(19) United States
(12) Patent Application Publication
(10) Pub. No.: US 2010/0312709 A1
(43) Pub. Date: Dec. 9, 2010

(54) PAYMENT APPLICATION PIN DATA SELF-ENCRYPTION

(75) Inventor: Ian Maddocks, Milton Keynes (GB)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Dynamic Card Solutions International, Englewood, CO (US)

(21) Appl. No.: 12/576,900

(22) Filed: Oct. 9, 2009

Related U.S. Application Data
(63) Continuation-in-part of application No. 12/479,490, filed on Jun. 5, 2009.

(51) Int. Cl. H04L 9/32; G06Q 20/00

(52) U.S. Cl. 705/72

(57) ABSTRACT

A system to support the secure transportation a PIN value protected by the cryptographic features inherent in smart payment application, such as those found in EMV smart cards is described. A user can initiate the protection of the PIN using a personal unwired smart card reader, rather than using a system, such as an ATM machine, a utilize the same a smart device when then payment application is based on a smart device. The payment application, provides a cryptogram code, which can contain the user's selected PIN. The cryptogram code is delivered to the card issuer's PIN management system via various methods, including the user transposing the code from payment application host device's screen to the card issuer's website or audio DTMF transmission from the payment application host device's speaker to the card issuer IVR system, or direct communications through the payment application host device.

### PRIORITY CLAIM

The application is a continuation-in-part (CIP) application which claims priority to U.S. patent application Ser. No. 12/479,490, entitled SMART CARD PIN MANAGEMENT VIA AN UNCONNECTED READER, filed on Jun. 5, 2009, which is incorporated by reference in its entirety for any and all purposes.

### BACKGROUND OF THE INVENTION

Adoption of smart devices to support financial payments has become prevalent around the world primarily with the use of smart cards. Smart cards, as defined by ISO 7816, are credit card sized devices with the addition of a small micro-processor embedded within the plastic with external accessible electrical contact points. While smart cards are the dominant smart payment device, there is convergence between other consumer devices and payment forms, initially this has been seen with smart (mobile) phones being loaded with payment applications.

A security feature of the payment functionality within such devices is often to restrict usage until a personal identification number PIN code has been entered, whereby the functionality becomes unlocked for a single payment or a short amount of time. Hence, the smart device's payment application needs to capture the PIN and validate it either off-line, to a PIN previously loaded into the payment application, or on-line to a payment Issuer.

With the need to remember several PINS used for payment cards and having the opportunity to have multiple payment accounts on a single smart device it becomes increasingly difficult for the user to remember the correct PIN or the user may confuse which PIN is associated with which account. A method to allow the user to select a new PIN will help the user with their PIN management.

When the issuer wishes to synchronize the PIN on a mobile payment device with a PIN used elsewhere by his or her customer, a mechanism is required to allow the secure transmission of the PIN from the smart device to the Issuer.

For smart devices that need to conduct on-line PIN validation, the ability for the payment application to cryptographically protect the user supplied PIN before transmission to the payment Issuer providing a secure solution without the need to introduce additional key management or payment application functionality.

### BRIEF SUMMARY OF THE INVENTION

Embodiments presented herein are generally directed to a system where a user can securely inform the issuer of a PIN utilizing a payment application supplied by an Issuer to cryptographically protect it. Example payment applications include but are not limited to smart cards and mobile phones embedded or loaded with a payment application.

The process to achieve the secure encapsulation requires the use of an appliance and/or software to communicate with the payment application. This payment application host device in the case of a smart card based payment application is a smart card reader, connected or unconnected to a user computer, which instructs the user to enter a PIN and operates the payment application to produce a cryptogram which is then sent to the Issuer's PIN change management system to further process and complete the PIN processing. This payment application host device for the smart device based payment application, such as a smart phone, is typically the smart device itself, which provides application processing, user interaction (keypad & display) and Issuer communications in order for the required functionality to operate and produce a protected PIN cryptogram and then send the cryptogram to the Issuer's PIN management system for further processing.

The PIN value is embedded within the request cryptogram sent to the Issuer's PIN management system. Privacy and integrity are managed purely by the payment application. The software and hardware driving the payment application provide process flow and communications interfaces, directly or in directly to the payment Issuer, but no cryptographic support.

With the payment application being active and operated by the host application, the User is prompted to enter the PIN value into the payment application host device, such as the smart card reader or mobile phone. The payment application is driven, by way of a payment transaction, to create a cryptogram using data including the PIN value.

For smart card based payment applications the smart card reader converts the resultant cryptogram into a form suitable for transmission. Examples of the cryptogram transmission include: 1) Compacting and decimalization, and displayed to User, 2) Audio DTMF encoding via device speaker. The User has the task of providing the cryptogram data to the Issuer via methods such as: 1) Entry of data on to web page, 2) Telephone connection, 3) Email, and 4) SMS text message. In other embodiments the smart card reader could be connected to the User's computer to enable the transmission of messages.

For mobile phone based payment applications the host application will communicate the cryptogram to the payment Issuer through the mobile phone's online communications. In other embodiments the mobile phone display can display the value ready for the user to enter the value into an Issuer portal, such as web page.

The Issuer's PIN management system uses the process described in this document to validate the cryptogram and retrieve the PIN, using user account information known to the system and additional data conveyed within the message transmitted from the payment application host device to the Issuer.

Further, utilizing the cryptogram and retrieved the PIN, If the intent is to perform a PIN Change the Issuer's PIN management system can build a PIN change command code. This PIN change command code (alternatively known as an EMV PIN Change/Unblock script in the EMV payment environment) can be transmitted back to the payment application host device and on to the payment application. Alternatively, the PIN management system may hold the PIN change command until payment devices in use by the user, such as cards and/or mobile based payment applications, appear online, such as a Point of Sale (POS) or Automated Teller Machine (ATM). The detail of how the PIN update command is transmitted to the payment application is not part of this document.

Alternatively if the intend of the PIN transmission is for the Issuer to validate the user by comparing the entered PIN against the Issuer record of the PIN then, the Issuer's PIN management system will conduct the comparison and inform the payment application host device application as appropriate.

### BRIEF DESCRIPTION OF THE DRAWINGS

The present disclosure is described in conjunction with the appended figures:

FIG. 1 is a block diagram of an embodiment of a system operable to manage the PIN of a user payment application;

FIG. 2 is a set of hardware and/or software block diagrams of embodiments of a payment application host device and a PIN management system for use in a system for managing a user's PIN;

FIGS. 3A-B are block diagrams of embodiments of the data presented to the payment application to initiate the creation of a cryptogram;

FIG. 4 is a flow diagram of an embodiment of a process for creating a PIN change request message having a PIN change request;

FIG. 5 is a flow diagram of an embodiment of a process for determining that the PIN change request message is a PIN change request;

FIG. 6 is a block diagram of an embodiment of a computer system for use in the system for authorizing contactless payments.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION OF THE INVENTION

The following section illustrates the processing steps required to support the user desire to instruct the Issuer's systems of a PIN change. In other embodiments the processing steps could be used to allow the Issuer's systems to validate the PIN entered by the user matches the PIN value held on file.

Embodiments of the disclosure generally relate to systems and methods for managing a user's PIN associated with the user's payment application. In embodiments, a user supports the communication between an Issuer's PIN management system and the payment application/payment application host device. The communications can be used by the Internet or other public or private network, such as a feature provided on the Issuer's website, telephone, text messaging, email or other open channel open between the User community and the Issuer. In other embodiments the payment application host device interfaces with the User's computer which in turn has a communication connection to the Issuer's systems.

The user communicates with a payment application host device at the user's facility. A user instructs the payment application host device to complete a PIN change using the payment application. The payment application host device reads information from the payment application. Further, the user can enter information into the payment application host device, for example, the new PIN. A message is created using the information from the payment application and the information from the user, namely the new PIN. The message includes the new PIN requested in a cryptographically protected form. The user supports the forwarding of the message to the PIN management system.

Generally, current systems do not have the ability to protect the user's new PIN through channels other than an open connection between the system of the Issuer and the payment application acceptance device, such as an ATM or dedicated hardware.

The PIN management system can be software at a card issuer or a separate system in communication with the card issuer. The PIN management system can receive the message from the user and send the retrieved new PIN as a PIN change request over a private network to the card issuer. The card issuer uses the provided data to build a PIN change command which may need to be passed to the payment application and/or passed onto other associated payment applications of the user.

The embodiments here are for use with existing payment application cryptogram protocols such as those defined in EMVCo LLC specifications (EMV v4.2 Book 3 section 6.5.5).

Specific details are given in the following description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments. In some embodiments, a computing system may be used to execute any of the tasks or operations described herein. In embodiments, a computing system includes memory and a processor and is operable to execute computer-executable instructions stored on a computer-readable medium that define processes or operations described herein.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “computer-readable medium” or “storage medium” may represent one or more devices for storing data, including read-only memory (ROM), random access memory (RAM), magnetic RAM, core memory, magnetic disk storage mediums, optical storage mediums, flash memory devices and/or other machine-readable mediums for storing information. The term “machine-readable medium” includes, but is not limited to, portable or fixed storage devices, optical storage devices, wireless channels and various other mediums capable of storing, containing or carrying instruction(s) and/or data.

The usage of the user to assist in the transfer of data between the Issuer systems and the payment application device includes, but is not limited to, web site entry and display, audio transmission of codes, visual/optical transmission of codes.

Furthermore implementations may be designed to link the Issuer systems and the payment application device via the use of a personal computer connected to the Internet or other such public network, removing the user responsibility of data transfer. In such as case the user 104 will be replaced by a personal computer operated by the user.

Embodiments may be implemented by hardware, software, firmware, middleware, microcode, hardware description languages, or any combination thereof. When implemented in software, firmware, middleware or microcode, the program code or code segments to perform the necessary tasks may be stored in a machine-readable medium such as storage medium. A processor(s) may perform the necessary tasks. A code segment may represent a procedure, a function, a subprogram, a program, a routine, a subroutine, a module, an object, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

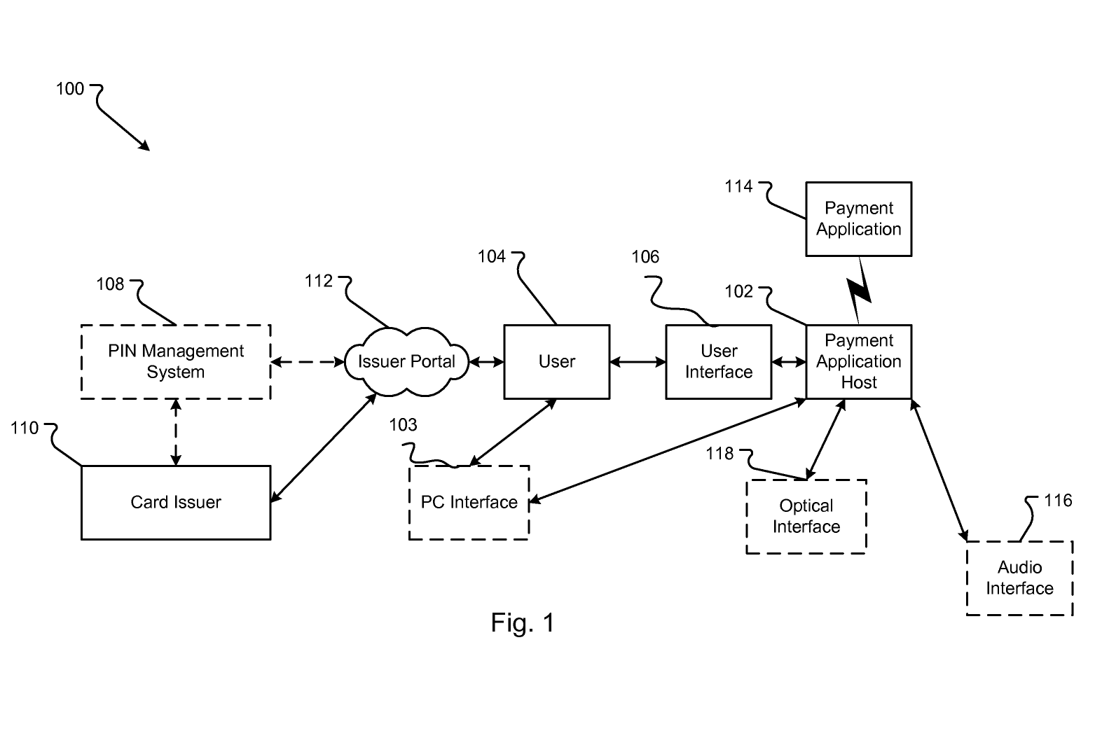

An embodiment of a system 100 for providing management of a user's PIN on a payment application 114 is shown in FIG. 1. A user 104 will communicate with a payment application host 102. The payment application host 102 is a system or device having hardware and/or software that can communicate with a payment application 114. A payment application 114 is a device or soft implementation that offers payment application processing. The payment application host 102, in embodiments, can include or be in communication with a user interface 106 and/or a PC interface 103 that allows the user to enter information into or receive information from the payment application host 102. Optical interface 118 can be included to allow data from an optical source being a static image or a moving image sequence to be interpreted by the payment application host 102. Audio interface 116 may comprise a speaker and/or microphone to enable data to be transferred as audible signals such as, but not limited to, DTMF tones.

In embodiments, the user 104 is operable to receive communications from and send communications to the payment application host 102. Further, the user 104 is operable to receive communications from and send communications to a PIN management system 108. In embodiments, the user 104 communicates with the PIN management system 108 via an Issuer portal 112. The portal is a public network, for example, a web site on the Internet, telephone system available via a published number or email address provided to the user. The user 104 may be a supported by devices such as a laptop computer, a desktop computer, a mobile phone, a cellular device, a personal digital assistant with communication capability, etc. In alternative embodiments, one or more portions of the portal 112 between the user 104 and the PIN management system 108 include wired or wireless media, for example, a LAN, WAN, the Internet, a telephone system, etc. In further embodiments the payment application host 102 will communicate with the PIN management system 108 via a wired connection to the User's computer.

The PIN management system 108, in embodiments, is part of the card issuer 110 or a physically separate entity that processes PIN management requests on behalf of a card issuer 110 desiring to allow PIN changes over a public network. The PIN management system 108 may communicate PIN change requests to a card issuer. In other embodiments, the PIN management system 108 may be a function of the card issuer 110. The PIN management system 108 may have a predefined relationship with the card issuer 110 that issued the payment application 114, such that the PIN management system 108 communicates requests and receives commands over a private network between the PIN management system 108 and the card issuer 110.

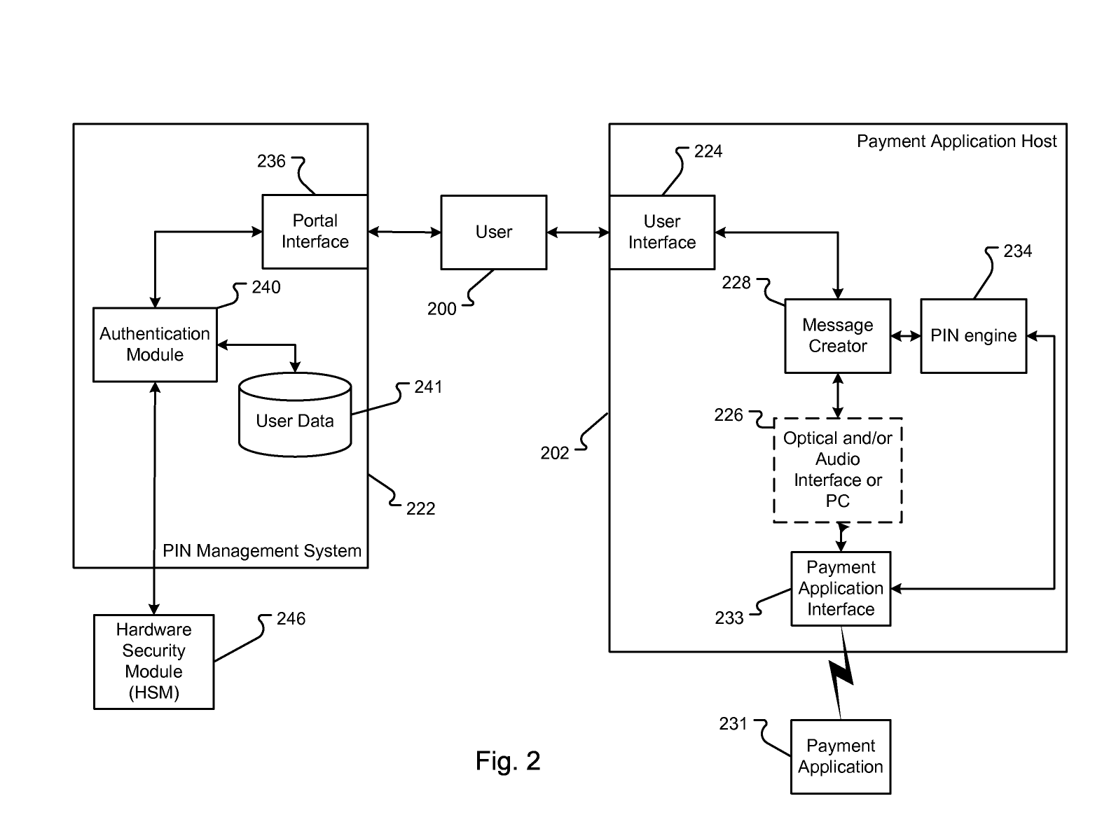

Turning now to FIG. 2, which illustrates a payment application host device and a PIN management system for use in a system for processing a user's PIN election. The PIN engine 234 can verify the current PIN and instructs the payment application 231 to create a cryptogram of the new PIN chosen by the user. A PIN engine can receive the new PIN from the user interface 224 through the Message creator 228. To verify the old PIN or create a cryptogram of the new PIN, the PIN engine 234 communicates with the payment application interface 233. The PIN engine 234 reads the messages from the payment application 231 to extract information for generating the messages for the payment application 231. The message creator 228 is either hardware, software, or both hardware and software that builds, condenses and formats messages to and from the PIN management system 222. The message creator 228 receives the PIN change information from the PIN engine 234. In embodiments, the message creator 228 prepares the cryptogram or other specially designed message for presentation to the user 200 on the user interface 224 or output via the optical and/or audio or PC interface 226. The user may copy the message from the user interface display into another application to send to the PIN management system 222. In other embodiments, the message creator 228 automatically sends the message through the user 200's computer to the PIN management system 222. The message can be a PIN change request message that includes the new PIN and is recognized as a PIN change request. Authentication of the user to the PIN management system is out of bounds but could include the current PIN validation performed by the payment application 231.

The portal interface 236 is operable to communicate with the user 200 or user 200's computer. The portal interface 236 may be any technology or system that can complete communications, such as a web site, telephone, IVR, email, text messaging, TCP/IP or other technology.

The authentication module 240, in embodiments, is a module that authenticates the payment application data, optionally validating the user authentication to the payment application and searching for a PIN within the cryptogram via an exhaustive search, using the information sent from the user 200 optionally with information sent from the payment application 231. The authentication information may include one or more of, but is not limited to, the user's name, the user's account number, the user's PIN, a password, a user-selected logon name, or another identifier for the user or the payment application. Thus, the authentication module 240 is operable to extract this information from the communication from the user 200 and authenticate the information to ensure the authenticity of the transaction. In alternative embodiments, the authentication module 240 is part of the HSM 246. If an authentication is unsuccessful, a signal may be sent to the user 200.

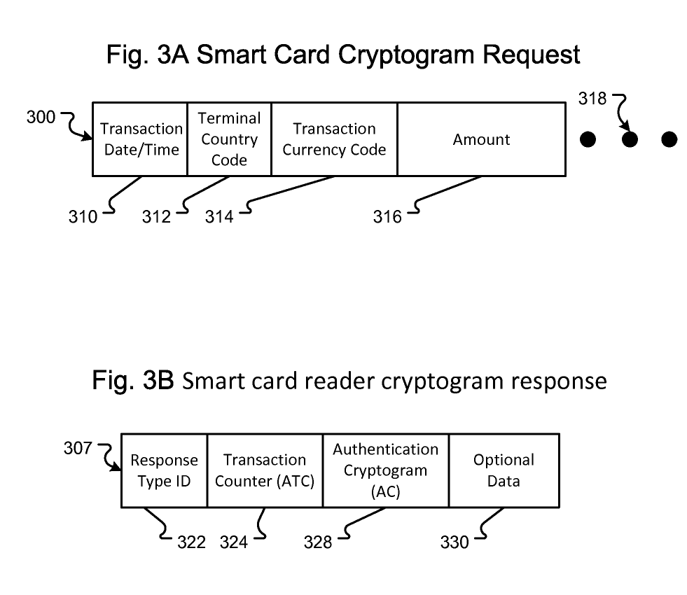

One or more data structures used to store information in one or more components or transport information between the payment application 231, payment application interface 233, the user 200, and the PIN management system 222 are shown in FIGS. 3A-B.

The data structure field 300 in FIG. 3A, in embodiments, includes one or more fields used in typical payment application cryptogram calculation; the fields may include, but are not limited to, Transaction Date/Time (310), Terminal Country Code (312), Transaction Currency Code (314), Transaction Amount (316). The precise details required to be provided by the payment application host 102 to the payment application 114 are defined by the developer of the payment application.

The transaction details field 300 includes one or more fields containing information about the “pseudo transaction”. The transaction details field 300 represents a pseudo transaction because the message, while formatted like a payment transaction message, is encoded to be a PIN change request message. As such, the transaction details field 300 may contain fields similar to a typical payment transaction request message but may contain data representative of a PIN change request. The amount field 316 would typically contain the price being authorized for the transaction. For example, if the total for the transaction was $46.00, this amount would be entered in the amount field 316. Additional data elements may be required to be provided to the payment application as represented by the ellipses 318.

To provide the new PIN to the payment application so it can be included in the cryptogram, the new PIN is entered into one of the fields of the transaction details field 300. In embodiments, the new PIN is entered into the amount field 316. As such, rather than containing an amount of a transaction, the amount field 316 includes the new PIN and can be recognized as having the new PIN. In embodiments other fields can be used and where practical the last field should be used to simplify processing by the PIN management system. In one embodiment, all zeroes, other null values, or values determined from the payment application are entered into at least a portion or one or more data fields in the transaction details field 300. For example, all zeroes are entered into the Transaction Date field 310, and Transaction Time field 312. In another embodiment, a predetermined code is entered into one or more fields. For example, the Terminal Country Code field 314 will contain a value previously known to the payment application host 102 by interrogation of the payment application 114.

FIG. 3B illustrates transaction details 307, which includes encrypted elements and can be verified by holders of the cryptographic key, generally restricted to the card issuer or the card issuer's service providers. In alternative embodiments, the transaction details 307 include one or more unencrypted items, such as Usage Counters held by the card. In still other embodiments, the transaction details 307 include both encrypted and unencrypted copies of portions of the transaction details 300, along with other internal payment application data, such as Response Type ID 322, Transaction Counter 324, and Optional Data 330. Encryption also prevents a nefarious individual from having access to the PIN change request information, which could allow payment application transactions to be altered or fraudulent transactions to be generated.

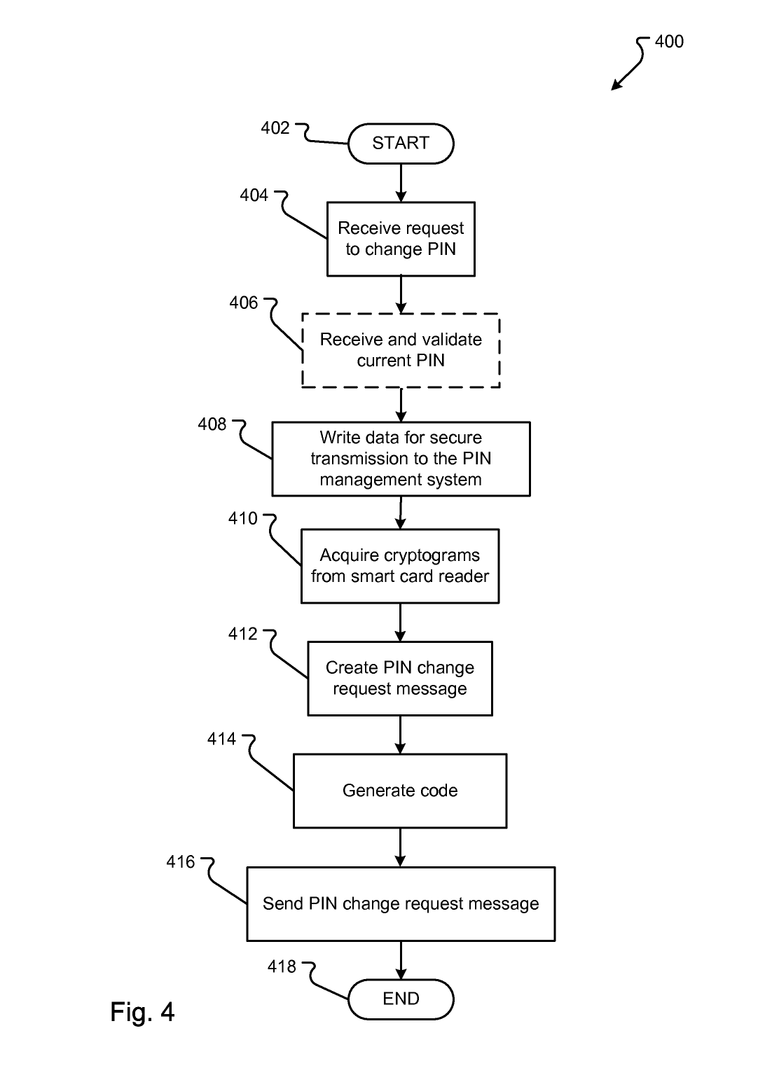

An embodiment of a method 400 executed at a payment application host 202 for generating a cryptogram request that is included with the PIN change request is shown in FIG. 4. In embodiments, the method 400 generally begins with a START operation 402 and terminates with an END operation 418. The steps shown in the method 400 may be executed in a computer system or other electronic device as a set of computer-executable instructions. While a logical order is shown in FIG. 4, the steps shown or described can, in some circumstances, be executed in an order different from that presented herein. Further, the steps shown in FIG. 4 may only be a subset or may be substituted for other steps not shown in FIG. 4. The method 400 of FIG. 4 will be explained with reference to the drawings in FIGS. 1-3B.

The payment application host 202 receives a request to change the PIN for a payment application 231 in step 404. In embodiments, the user interface 224 of the payment application host 202 receives a selection of a PIN change, for example, a button or menu selection.

The payment application host 202 may then prompt the user for a current PIN. Entry of the current PIN is not required as it may no longer be known to the user. Step 406, receive and validate current PIN, optionally occurs if the user wishes to enter the current PIN, via user interface 224; then the current PIN is sent to the message creator 228. The payment application interface 233 interacts with the payment application 231.

The payment application host 202 may then prompt the user for a new PIN. The new PIN may be input into user interface 224. The new PIN is sent to the message creator 228 and/or the PIN engine 234. The payment application interface 233 interacts with the payment application 231. In response to the request, the message creator 228 can direct the PIN engine 234 to extract information from the payment application 231. The PIN engine 234 sends the information request to the payment application interface 233, which interacts with the payment application 231.

In response to the request, the message creator 228 can direct the payment application interface 233 to extract information from the payment application 231, for example, the payment application's Currency Code, Country Code, etc.

Entering the current PIN onto a payment application capable of validating the user PIN offline enables the payment application cryptogram 328 to indicate to the PIN management system the successful authentication of the user. In other embodiments, the current PIN is included in the cryptogram 328, enabling the transport of the encrypted current PIN to be transferred to the PIN management system for authentication of the user. In further embodiments, the authentication of the user is conducted via alternative methods by the PIN management system including, but not limited to, user credentials validated via online banking username and password onto a card issuer web site.

The Message creator 228 may build the cryptogram generation command to the payment application 231 utilizing zeroes or other predetermined codes entered into one or more of the fields of the cryptogram request message, as explained in conjunction with FIG. 3A. Further, the Message creator 228 can write data for secure transmission to the PIN management system, such as the new PIN received from the user and/or the current PIN, into the cryptogram request message in step 408. For example, the Message creator 228 enters the new PIN in the amount field 316 of the cryptogram request message as explained in conjunction with FIG. 3A.

A cryptogram, or other information, is acquired in step 410. In embodiments, the payment application interface 233 acquires the information from the payment application 231 and sends the information to the Message creator 228. Further, the PIN change request message is created in step 412. The PIN change request message can include the cryptogram(s) and/or other data received from the payment application 231.

The Message creator 228 generates a code in step 414 and formats the data into a format suitable for transmission, via the User interface 224, optical and/or audio or PC interface 226, and/or interface to User's computer. Depending on the transmission method of the PIN change request message to the PIN management system various encoding methods can be used, such as, but not limited to, DTMF tones in order for the message data to be transmitted and received by the PIN management system, or compacting in order to reduce the amount of data transferred and format the data into a limited range of characters such as but not, limited to 0 . . . 9(decimal), 0 . . . 9+A . . . Z (numeric plus uppercase letters), 0 . . . 9+A . . . Z+a . . . z (numeric, uppercase letters plus lowercase letters), all standard keyboard characters (for example ASCII characters codes 0x21 . . . 0x7E inclusive).

The payment application host 202 sends or forwards the cryptogram request message in step 416. The PIN change request message can be sent by the user interface 224, the optical and/or audio or PC interface 226 or user computer interface to be sent to the PIN management system 222.

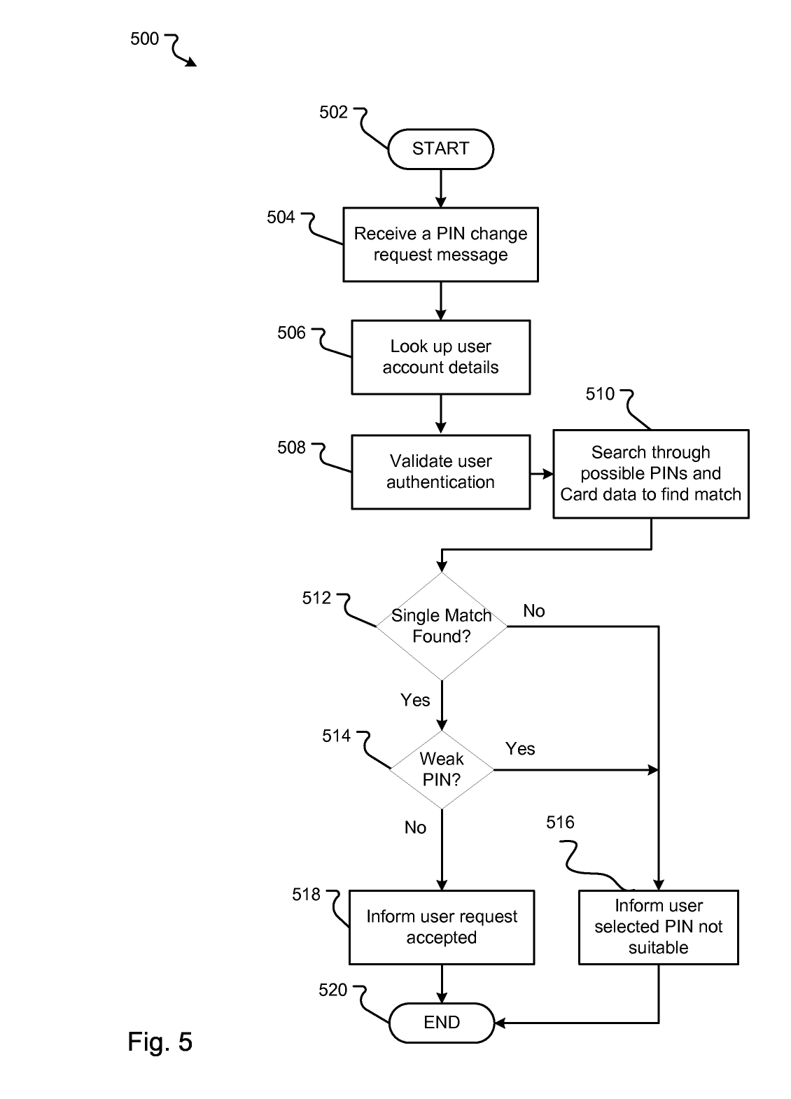

An embodiment of a method 500 executed at a PIN management system 222 for processing a PIN change request and generating PIN change command for a payment application 231 is shown in FIG. 5. In embodiments, the method 500 generally begins with a START operation 502 and terminates with an END operation 520. The steps shown in the method 500 may be executed in a computer system as a set of computer-executable instructions. While a logical order is shown in FIG. 5, the steps shown or described can, in some circumstances, be executed in a different order than presented herein. Further, the steps shown in FIG. 5 may only be a subset or may be substituted for other steps not shown in FIG. 5. The method 500 of FIG. 5 is explained with reference to the drawings in FIGS. 1 and 2.

The PIN change management system 222 receives a PIN change request message in step 504. The PIN change request message can be as described in conjunction with FIG. 3B. The portal interface 236 may receive web requests from the user 200 having a PIN change request message. In other embodiments the portal interface 236 may receive messages as DTMF signals. In further embodiments the portal interface 236 may receive a TCP/IP message from a front-end computer.

The Authentication module 240 reads the PIN change request message in step 504. The Authentication module re-formats where the PIN change request is based on the fully formed cryptogram and any other associated data.

Information attained previously, such as the user's account number, data in the PIN change request message, along with payment application state information retrieved from the User Data 241 database, the PIN change request message, or a mixture of both, is required to retrieve the cryptographically protected PIN.

The Authentication Module 240 determines the validity the user's credentials and of the cryptogram. At step 506, the user account details are looked up. At step 508 the Authentication module 240 may determine if the user has been authenticated by the payment application 231 or conduct user authentication with the current PIN cryptographically embedded within the PIN change request message. In other embodiments and if the users have no knowledge of their current PIN, the Authentication module will ensure satisfactory methods of user authentication are or have been conducted.

Furthermore, the Authentication Module 240 in step 510 is used to validate the cryptogram from the PIN management system by attempting to duplicate the same data that was used in the creation of the cryptogram by the payment application 231, executed by the payment application host 202 during step 414. In duplicating possible data values that could have been used the Authentication Module 240 verifies the generated cryptogram with the supplied cryptogram. Given that some elements of the cryptogram inputs are unknown, i.e., the new PIN and possibly other payment application state values and counters that are not predicable, the Authentication Module 240 must make multiple attempts to recreate the same input data, resulting in the maximum number of attempts being 10*n*m, where n is the number of PIN digits and m is the number of combinations of payment application state information that is not known to the Authentication Module 240.

In embodiments, for the purposes of speed and security the processing of step 510 would typically be conducted within a HSM 246 under the control the Authentication Module 240. If it is not possible to verify the cryptogram against the searched values or multiple cryptogram matches were found, the user is informed to re-try. In further embodiments, the results of the cryptogram matches will be maintained and compared against the repeated requests, and upon the repeated requests also returning multiple matches a single common match may be found existing in the original and repeats (step 512). If it is determined that a single match is not found, then the user is informed that the selected PIN is not suitable (step 516).

In other embodiments, the amount of PIN digits embedded within the can be less than the total PIN digits. In this case, the PIN data excluded from the cryptogram (AC) calculation must be conveyed via alternative methods, such as XOR, the excluded PIN data with data values known to the Payment application host 202 and the PIN Management system 222; examples include the Card Verification Value/Code (CVV/CVC) which is than appended to the PIN change request message. Thereby the PIN easily retrievable by another XOR operation using the Payment application host 202 XOR'ed value with the known value.

The PIN data retrieved from the cryptogram iterative search is concatenated with any PIN data retrieved through alternative methods to recreate the new PIN to the PIN Management System 222.

Furthermore, if it is determined that a single match is found in step 512, then the Authentication Module 240 may validate the new PIN against the card issuer's weak PIN rules and reject PIN change requests determined to be weak at step 514. If the PIN is determined to be weak (or otherwise unsuitable), at step 516 the user is informed that the selected PIN is unsuitable. Otherwise the process continues to step 518, where the user is informed his or her new PIN has been accepted, and the PIN management system can move forward as required with the new PIN data.

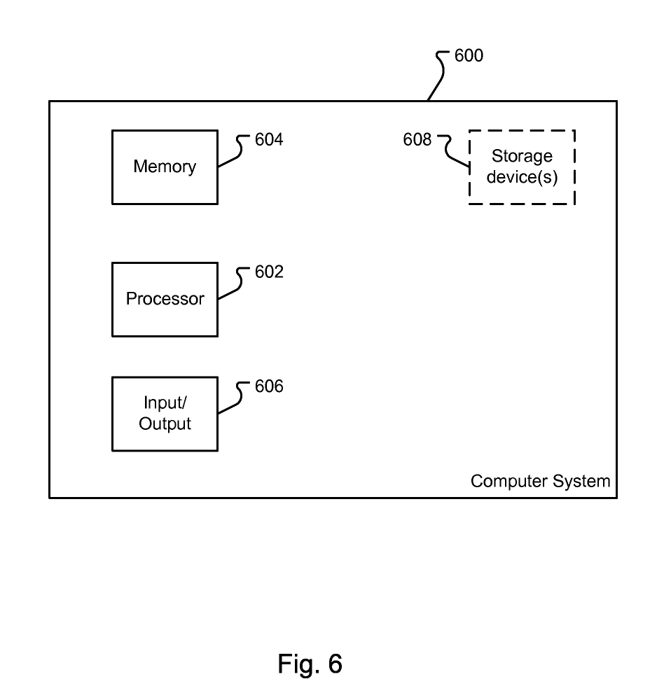

Embodiments of the different systems represented in this disclosure, which may include the PIN management system 222, the user's 200 computer, and/or the payment application host 202, may be a computer system, such as computer system 600 shown in FIG. 6. While a basic computer system is shown, one skilled in the art will recognize the configuration changes and/or modifications that may be required to make operable the systems (e.g. payment application host 202, PIN management system 222, etc.) described herein. The computer system 600 comprises a processor 602, which completes the operations described in conjunction with FIGS. 4 and 5 or makes the systems operable described in conjunction with FIG. 1. Further, the computer system 600 can execute functions in response to receiving the data structures described in FIGS. 3A-3B. The processor 602 may be any type of processor operable to complete the operations or implement the systems described herein. For example, the processor 602 may be an Intel Pentium processor, an ASIC, an FPGA, or other device.

The computer system 600 also comprises memory 604 to hold data or code being executed by processor 602. The memory 604 may permanently or temporarily store the instructions described in conjunction with FIGS. 4 and 5 or the data elements described in conjunction with FIGS. 3A-3B. Memory may be classified as a computer-readable medium, for example, RAM, ROM, magnetic media, optical media, etc.

The computer system 600 also can comprise software elements, including an operating system and/or other code, such as one or more application programs for authorizing contactless payments at any of the PIN management system 222 and/or the payment application host 202. The application programs may comprise computer programs described herein, and/or may be designed to implement methods described herein and/or configure systems described herein. Merely by way of example, one or more procedures described with respect to the method(s) discussed in conjunction with FIGS. 4 and 5 might be implemented as code and/or instructions executable by the computer system 600 (and/or the processor 602 within the computer system 600).

A set of these instructions and/or this code might be stored on a computer-readable storage medium, such as the storage device(s) 608 or memory 604. In some cases, the storage medium might be incorporated within a computer system. In other embodiments, the storage medium might be separate from a computer system (i.e., a removable medium, such as a compact disc, etc.), and/or provided in an installation package, such that the storage medium can be used to program a general purpose computer with the instructions/code stored thereon. These instructions might take the form of executable code, which is executable by the computer system 600 and/or might take the form of source and/or installable code, which, upon compilation and/or installation on the computer system 600 (e.g., using any of a variety of generally available compilers, installation programs, compression/decompression utilities, etc.) then takes the form of executable code.

Further embodiments of the computer system 600 comprise input/output (I/O) modules of systems 606. I/O systems 606 may include displays such as LCDs, plasma screen, cathode ray tubes, etc. The displays can provide a visual representation of data to a user. I/O system 606 may also include input devices such as mice, keyboards, touch screens, etc. Input devices allow the user to input information into the computer system. I/O systems 606 may also comprise communication systems such as wired, wireless, or other communication systems. Further, communication systems may communicate with peripheral devices, such as printers, modems, or other devices.

In light of the above description, a number of advantages of the present invention are readily apparent. For example, the systems allow for a user to change the PIN associated with the payment application at a user's home or business, or in embodiments when the user has access to a telephone.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

While the principles of the invention have been described above in connection with specific apparatuses and methods, it is to be clearly understood that this description is made only by way of example and not as limitation on the scope of the invention.

What is claimed is:

1. A cryptographically secured personal identification number (PIN) transport system based on payment application digital signature services as provided with EMV payment applications, the system comprising:
a payment application host device in communication with a user, user computer and/or user telephone, the payment application host operable to receive a secure entry PIN request message initiated by the user in conjunction with a payment application and payment application host device, the payment application host device operable to forward the secured PIN message;
a message processor in communication with the payment application host device, the message processor operable to interpret and recover the secured PIN message by performing an exhaustive search of all variants of PIN value data results in a digital signature match or matches against the cryptographically secured element of the PIN message; and
the message processor further operable to continue processing of the selection PIN for purpose of a PIN change or a PIN validation.

2. The system as defined in claim 1, wherein a code comprises one or more zeroes entered into one or more fields of an authorization message, in order to get the payment application to provide the authorization message outside of a payment transaction.

3. The system as defined in claim 2, wherein the code is one or more zeroes entered into one or more fields of the authorization message.

4. The system as defined in claim 3, wherein zeroes are entered into a retailer identifier field.

5. The system as defined in claim 1, wherein zeroes are entered into a not required field.

6. The system as defined in claim 1, wherein the PIN is entered into an amount field of an authorization cryptogram field or substantially similar field.

7. The system as defined in claim 1, wherein the payment application host device comprises a user or a user computer.

8. A method for changing a PIN associated with a payment application, the method comprising:
a payment application host device receiving a request to change a PIN associated with a payment application;
the payment application host device receiving a new PIN;
the payment application host device acquiring information from the payment application;
the payment application host device creating a payment authorization cryptogram, at least in part, from the information acquired from the payment application and the new PIN, wherein the payment authorization cryptogram is an encoded PIN;
the payment application host device sending the payment authorization request to the user in a compacted form to a PIN management system through a web page;
the PIN management system retrieving the new PIN via an exhaustive search of the cryptograms calculated using all possible PIN values.

9. A method for a user to securely provide a payment application issuer a PIN value, the method comprising:
a payment application host device receiving a request to protect a PIN associated with the payment application issuer;
the payment application host device receiving a PIN;
the payment application device host acquiring information from the payment application;
the payment application host device creating a payment authorization cryptogram, at least in part, from the information acquired from the payment application and the PIN, wherein the payment authorization cryptogram is an encoded PIN;
the payment application host device sending the payment authorization request to the user in a compacted form;
sending the payment authorization request to a PIN management system though a web page;
the PIN management system retrieving the PIN via an exhaustive search of the cryptograms calculated using all possible PIN values.

10. A computer program stored on a computer-readable medium, the computer program embodied in one or more instructions for accepting a PIN associated with a payment application, the instructions when executed by a computer, causing that computer to:
receive a request to change a PIN associated with a payment application;
receive a new PIN;
acquire information from the payment application;
create a payment authorization cryptogram, at least in part, from the information acquired from the payment application and the new PIN, wherein the payment authorization cryptogram is an encoded PIN;
send the payment authorization request to the user in a compacted form;
send the payment authorization request to a PIN management system though a web page;
in response to sending the payment authorization request, receive a compacted PIN change response;
retrieve the new PIN via an exhaustive search of all possible PIN values.

11. A computer program stored on a computer-readable medium of claim 10, further comprising instructions to compacted/encode the payment authorization into a format for user transport.

12. A computer program stored on a computer-readable medium of claim 11, further comprising instructions to reconstruct the compacted/encoded payment authorization into original form.

13. A computer program stored on a computer-readable medium of claim 10, further comprising instructions to compacted/encode payment application update commands into a format for user transport.

14. A computer program stored on a computer-readable medium of claim 13, further comprising instructions to reconstruct the compacted/encoded payment application update commands into original form.
